(19) United States
(12) Patent Application Publication
(10) Pub. No.: US 2013/0035154 A1
(43) Pub. Date: Feb. 7, 2013

(54) GAMING SYSTEM, METHOD, AND PROGRAM PRODUCT WITH PAYTABLE ENHANCEMENTS

(71) Applicants: Brian Alexander Watkins, Austin, TX (US); Frank C. DeSimone, Henderson, NV (US); Clint Alan Owen, Rockdale, TX (US)

(72) Inventors: Brian Alexander Watkins, Austin, TX (US); Frank C. DeSimone, Henderson, NV (US); Clint Alan Owen, Rockdale, TX (US)

(73) Assignee: Multimedia Games, Inc.

(21) Appl. No.: 13/195,036

(22) Filed: Aug. 1, 2011

(51) Int. Cl. A63F 9/24; A63F 13/00

(52) U.S. Cl. 463/21

(57) ABSTRACT

A method includes displaying a number of enhancement symbols concurrently on a display device included at a gaming machine through which a wagering game may be played. The wagering game has a paytable providing at least one award level correlated to a payout value. Each of the displayed enhancement symbols is correlated to a payout modification. At least one of these enhancement symbols is selected and shown on the display device as being selected for a given play of the wagering game. The payout modification correlated to the selected enhancement symbol is used to identify a modified payout value for the outcome generated and displayed graphically for play of the game. This modified payout value is awarded for the given play of the game in lieu of or in addition to the payout value shown in the paytable for the outcome.

### COPYRIGHT NOTICE

A portion of the disclosure of this patent document contains material which is subject to copyright protection. The copyright owner has no objection to the facsimile reproduction of the patent document or the patent disclosure, as it appears in the Patent and Trademark Office patent files or records, but otherwise reserves all rights.

### BACKGROUND OF THE INVENTION

1. Field of the Invention

This invention relates to wagering games, gaming machines, gaming systems, and associated methods. More particularly, the invention relates to a wagering game in which awards provided for a play of the game may be enhanced in view of an enhancement symbol selection made for that play.

2. Description of the Related Art

Numerous types of wagering games have been developed in an attempt to provide players with new and varied gaming experiences. A play modifier is one popular feature applied particularly in reel-type gaming machines in which one or more symbol-bearing reels are used to display the result of a given play. One common play modifier is a multiplier which has the effect of multiplying the value of a winning combination in the game. A wild symbol is another common play modifier. A wild symbol is a symbol which represents any one of two or more symbols in a symbol set, and serves to produce more or better winning combinations for a give play of the game.

There remains a need in the wagering game field to provide wagering games which capture and maintain the player's interest and provide an entertaining and satisfying gaming experience.

### SUMMARY OF THE INVENTION

A method embodying one form of the present invention is performed through a gaming system in which a player may place a wager for the play of a game. The game is associated with a paytable which provides at least one award level which is correlated to a respective payout value. In this embodiment, the method includes displaying a number of enhancement symbols concurrently on a display device included at a gaming machine. Each of the displayed enhancement symbols is correlated to a payout modification such as, for example, the designation of a wild symbol, an outcome multiplier, or a variation in the way symbols in the game may be arranged to define a winning outcome. At least one of these enhancement symbols is selected and shown on the display device as having been selected. The payout modification correlated to the selected enhancement symbol is used to identify a modified payout value for the outcome generated and displayed graphically for play of the game. This modified payout value is different from the payout value for the outcome shown in the paytable. In this example method according to the invention, the modified payout value is awarded for the given play of the game in lieu of or in addition to the payout value shown in the paytable for the outcome.

In some embodiments of the invention, the game is a reel-type game in which the outcome for a play of the game is shown graphically by symbols appearing on one or more mechanical or video-generated reels. In other embodiments, the game is a playing card game such as a poker game. The enhancement symbol process according to the invention may also be applied to other wagering games.

A gaming system embodying one form of the invention includes at least one display device, a player input system, at least one processor, and at least one memory device storing instructions executable by the processor or processors. The instructions in this embodiment cause the display device or devices to concurrently display the enhancement symbols, and cause the processor or processors to generate an outcome for the play of a game in response to a wager entered through the player input system. The instructions in this embodiment also cause the display device or devices to display a graphical representation of the outcome and continue to display the number of enhancement symbols between the time that the wager is entered and the time that the graphical representation of the outcome is displayed. The instructions further cause the processor or processors in this embodiment to randomly or pseudo-randomly select one of the enhancement symbols and cause the display device or devices to visually indicate that the selected enhancement symbol has been selected for the given play of the game. Finally, the instructions cause the processor or processors to apply the payout modification correlated to the selected enhancement symbol to identify the modified payout value, and cause the modified payout value to be awarded for the play of the game.

The functions performed by the various processing devices in a gaming system implementing the present invention may be performed under the control of suitable program code. Thus the invention encompasses program products executable to provide various functions and operations to implement embodiments of the invention. A program product according to one or more forms of the present invention may include player input program code, game program code, display program code, play enhancement program code, and award program code. In this embodiment, the player input program code is executable to facilitate the receipt of player inputs through the player input system, while the game program code generates an outcome for the play of the game. The display program code may be responsible for controlling the display device or devices, such as to display a graphical representation of the outcome, and display the enhancement symbols. The play enhancement program code may control the selection of enhancement symbols, the visual indication of the selected enhancement symbol, and the application of the payout modification to identify the modified payout value for the play of the game. The payout program code may control the award of the modified payout value for the play of the game.

These and other advantages and features of the invention will be apparent from the following description of illustrative embodiments, considered along with the accompanying drawings.

### BRIEF DESCRIPTION OF THE DRAWINGS

FIG. 1 is a view in perspective of the front of a gaming machine which may be employed in embodiments of the present invention.

FIG. 2 is a diagrammatic representation of the gaming machine shown in FIG. 1.

FIG. 3 is a diagrammatic representation of a gaming network in which the present invention may be implemented.

FIG. 4 is a flow diagram illustrating a process flow according to one or more embodiments of the present invention.

FIG. 5 is a representation of a reel-type display device which may be used in embodiments of the present invention.

FIG. 6 is a representation of a paytable which may be applicable for the reel-type game illustrated in FIG. 5.

FIG. 7 is a representation of a playing card game having enhancement symbols according to a form of the present invention.

### DESCRIPTION OF ILLUSTRATIVE EMBODIMENTS

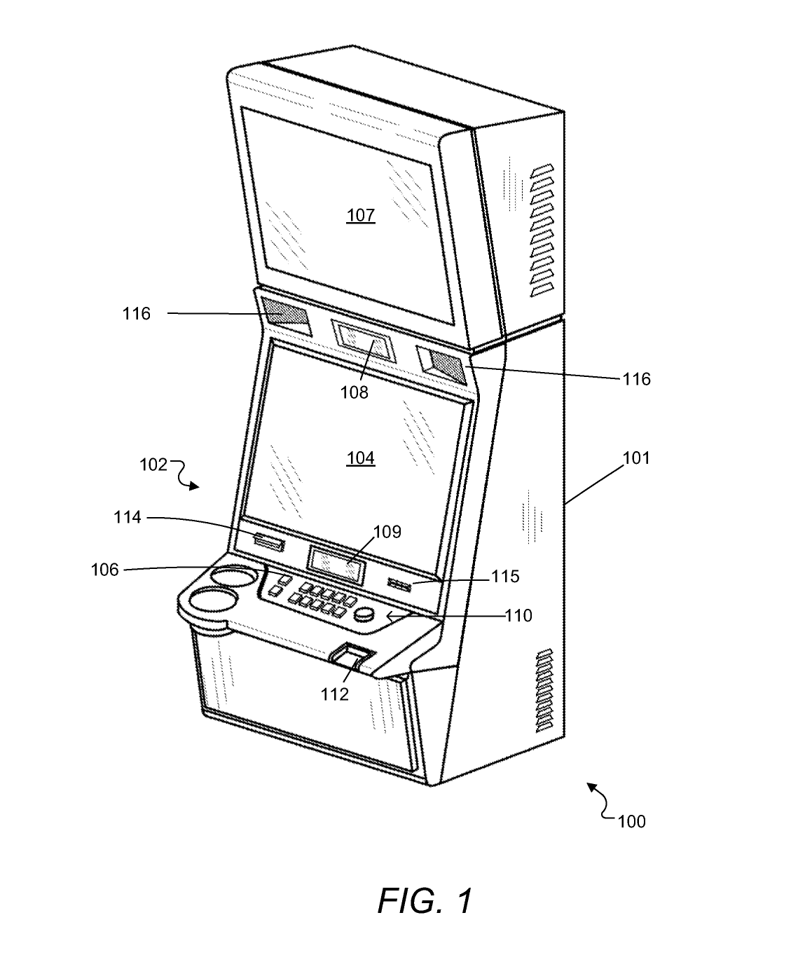

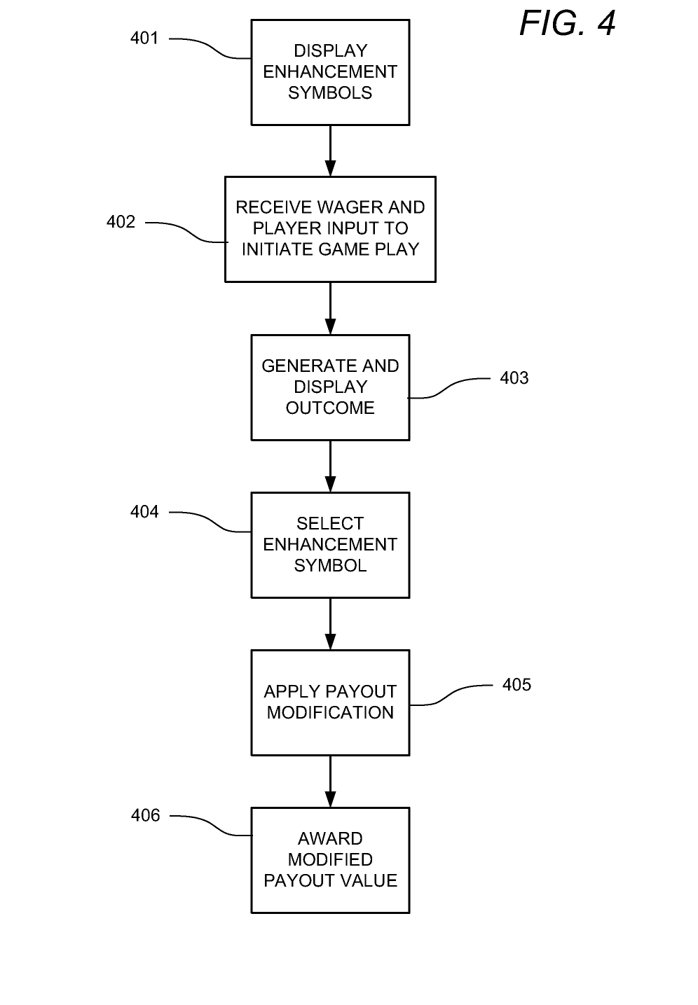

In the following description, FIGS. 1-3 will be used to describe example gaming systems through which the present invention may be implemented. Example embodiments of the invention will then be described in connection with FIGS. 4-7.

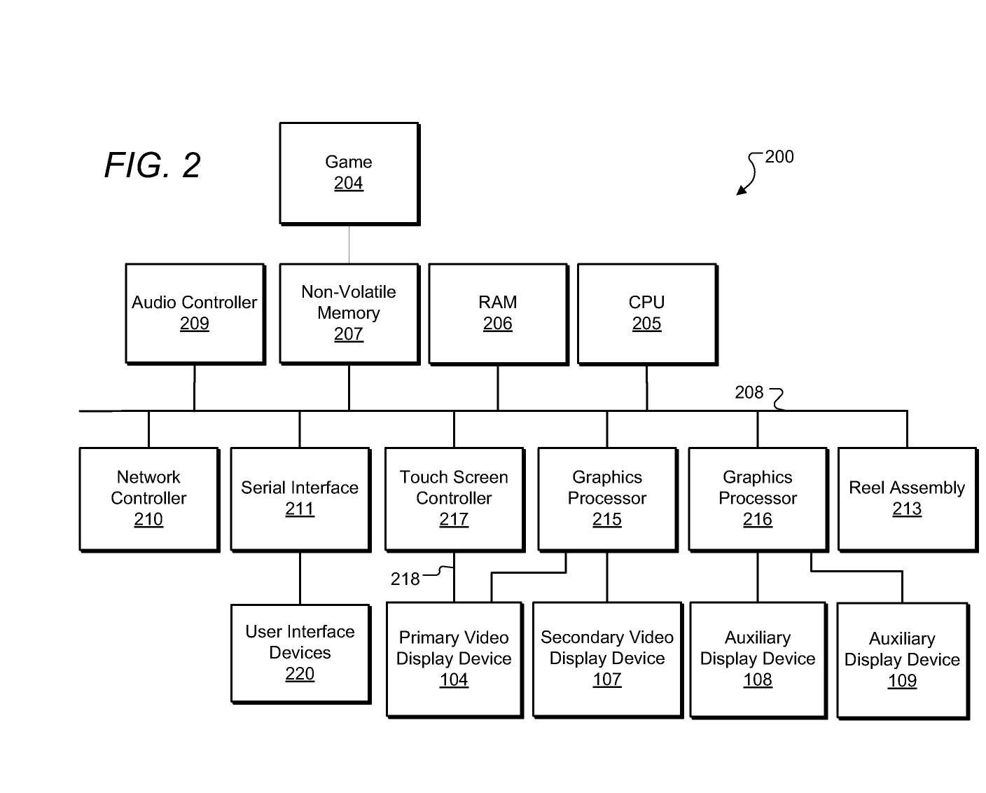

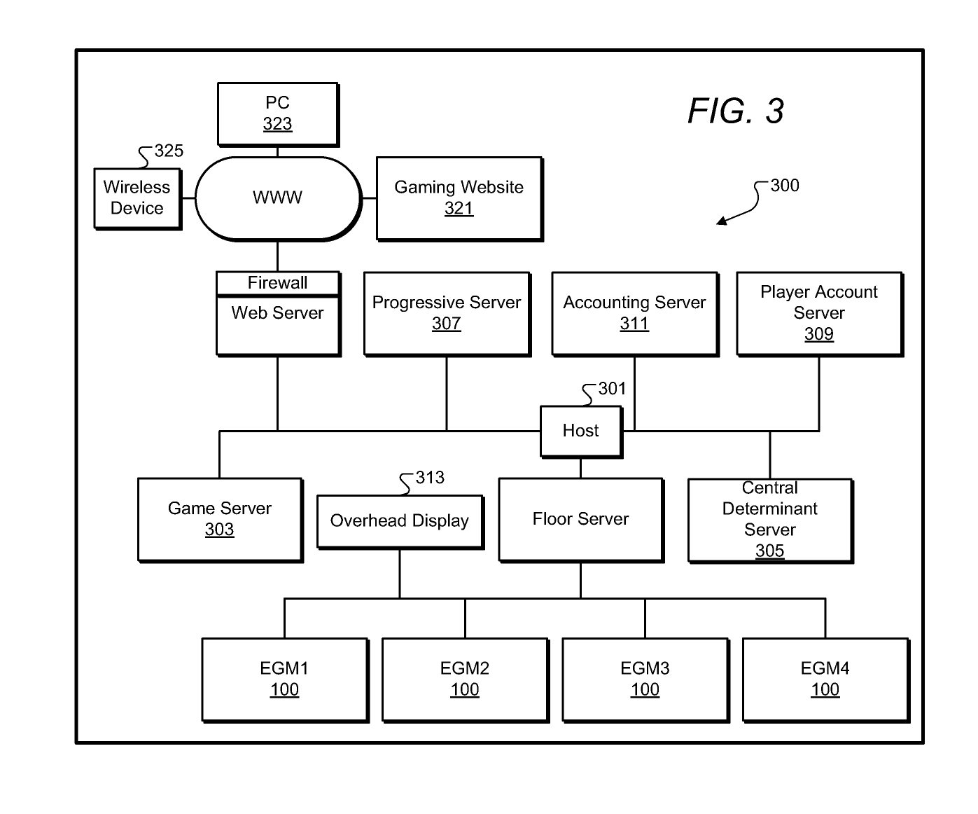

FIG. 1 shows a gaming machine 100 that may be used in implementing a game employing enhancement symbols according to the present invention. The block diagram of FIG. 2 shows further details of gaming machine 100 along with certain variations on the gaming machine, while FIG. 3 shows an example gaming network in which gaming machines such as gaming machine 100 may be employed.

Referring to FIG. 1, gaming machine 100 includes a cabinet 101 having a front side generally shown at reference numeral 102. A primary video display device 104 is mounted in a central portion of the front surface 102, with a button panel 106 positioned below the primary video display device and projecting forwardly from the plane of the primary video display device. In addition to primary video display device 104, the illustrated gaming machine 100 includes a secondary video display device 107 positioned above the primary video display device. Gaming machine 100 also includes two additional smaller auxiliary display devices, an upper auxiliary display device 108 and a lower auxiliary display device 109. It should also be noted that each display device referenced herein may include any suitable display device including a cathode ray tube, liquid crystal display, plasma display, LED display, or any other type of display device currently known or that may be developed in the future. As will be described further below in connection with FIG. 2 and elsewhere, it is also possible for gaming machines within the scope of the present invention to include mechanical elements such as mechanical reels.

The gaming machine 100 illustrated for purposes of example in FIG. 1 also includes a number of mechanical control buttons 110 mounted on button panel 106. These control buttons 110 may allow a player to select a bet level, select pay lines, select a type of game or game feature, and actually start a play in a primary game. Other forms of gaming machines through which the invention may be implemented may include switches, joysticks, or other mechanical input devices, and/or virtual buttons and other controls implemented on a suitable touch screen video display. For example, primary video display device 104 in gaming machine 100 provides a convenient display device for implementing touch screen controls in addition to or in lieu of mechanical controls. The player interface devices which receive player inputs to initiate the play of a game through the gaming machine, such as controls to select a wager amount for a given play and control to actually start a given play, may be referred to generally as a player input system.

It will be appreciated that gaming machines may also include a number of other player interface devices in addition to devices that are considered player controls for use in playing a particular game. Gaming machine 100 also includes a currency/voucher acceptor having an input ramp 112, a player card reader having a player card input 114, and a voucher/receipt printer having a voucher/receipt output 115. Numerous other types of player interface devices may be included in gaming machines that may be used according to the present invention.

A gaming machine which may be used to implement embodiments of the present invention may also include a sound system to provide an audio output to enhance the user's playing experience. For example, illustrated gaming machine 100 includes speakers 116 which may be driven by a suitable audio amplifier to provide a desired audio output at the gaming machine.

FIG. 2 shows a logical and hardware block diagram 200 of gaming machine 100 which includes a central processing unit (CPU) 205 along with random access memory 206 and nonvolatile memory or storage device 207. All of these devices are connected on a system bus 208 with an audio interface device 209, a network interface 210, and a serial interface 211. A graphics processor 215 is also connected on bus 208 and is connected to drive primary video display device 104 and secondary video display device 107 (both mounted on cabinet 101 as shown in FIG. 1). A second graphics processor 216 is also connected on bus 208 in this example to drive the auxiliary display devices 108 and 109 also shown in FIG. 1. As shown in FIG. 2, gaming machine 100 also includes a touch screen controller 217 connected to system bus 208. Touch screen controller 217 is also connected via signal path 218 to receive signals from a touch screen element associated with primary video display device 104. It will be appreciated that the touch screen element itself typically comprises a thin film that is secured over the display surface of primary video display device 104. The touch screen element itself is not illustrated or referenced separately in the figures.

Those familiar with data processing devices and systems will appreciate that other basic electronic components will be included in gaming machine 100 such as a power supply, cooling systems for the various system components, audio amplifiers, and other devices that are common in gaming machines. These additional devices are omitted from the drawings so as not to obscure the present invention in unnecessary detail.

All of the elements 205, 206, 207, 208, 209, 210, and 211 shown in FIG. 2 are elements commonly associated with a personal computer. These elements are preferably mounted on a standard personal computer chassis and housed in a standard personal computer housing which is itself mounted in cabinet 101 shown in FIG. 3A. Alternatively, the various electronic components may be mounted on one or more circuit boards housed within cabinet 101 without a separate enclosure such as those found in personal computers. Those familiar with data processing systems and the various data processing elements shown in FIG. 2 will appreciate that many variations on this illustrated structure may be used within the scope of the present invention. For example, since serial communications are commonly employed to communicate with a touch screen controller such as touch screen controller 217, the touch screen controller may not be connected on system bus 208, but instead include a serial communications line to serial interface 211, which may be a USB controller or a IEEE 1394 controller for example. It will also be appreciated that some of the devices shown in FIG. 2 as being connected directly on system bus 208 may in fact communicate with the other system components through a suitable expansion bus. Audio interface 209, for example, may be connected to the system via a PCI bus. System bus 208 is shown in FIG. 2 merely to indicate that the various components are connected in some fashion for communication with CPU 205 and is not intended to limit the invention to any particular bus architecture. Numerous other variations in the gaming machine internal structure and system may be used without departing from the principles of the present invention. For example, a gaming machine in some embodiments of the present invention may rely on one or more data processors which are located remotely from the gaming machine itself. Embodiments of the present invention may include no processor such as CPU 205 or graphics processors such as 215 and 216 at the gaming machine, and may instead rely on one or more remote processors.

It will also be appreciated that graphics processors are also commonly a part of modern computer systems. Although separate graphics processor 215 is shown for controlling primary video display device 104 and secondary video display device 107, and graphics processor 216 is shown for controlling both auxiliary display devices 108 and 109, CPU 205 may control all of the display devices directly without any intermediate graphics processor. The invention is not limited to any particular arrangement of processing devices for controlling the video display devices included with gaming machine 100. Also, a gaming machine implementing the present invention is not limited to any particular number of video display device or other types of display devices.

In the illustrated gaming machine 100, CPU 205 executes software which ultimately controls the entire gaming machine including the receipt of player inputs and the presentation of the graphic symbols displayed according to the invention through the display devices 104, 107, 108, and 109 associated with the gaming machine. CPU 205 also executes software related to communications handled through network interface 210, and software related to various peripheral devices such as those connected to the system through audio controller 209, serial interface 211, and touch screen controller 217. CPU 205 may also execute software to perform accounting functions associated with game play. Random access memory 206 provides memory for use by CPU 205 in executing its various software programs while the nonvolatile memory or storage device 207 may comprise a hard drive or other mass storage device providing storage for game software such as game program code 204 prior loading into random access memory 206 for execution, or for programs not in use or for other data generated or used in the course of gaming machine operation. Network interface 210 provides an interface to other components of a gaming system in which gaming machine 100 may be included. An example network will be described below in connection with FIG. 3.

It should be noted that the invention is not limited to gaming machines employing the personal computer-type arrangement of processing devices and interfaces shown in example gaming machine 100. Other gaming machines through which an enhancement symbol feature may be implemented may include one or more special purpose processing devices to perform the various processing steps for implementing the present invention. Unlike general purpose processing devices such as CPU 205, which may comprise an Intel Pentium or Core processor for example, these special purpose processing devices may not employ operational program code to direct the various processing steps.

The example gaming machine 100 which may be used to implement some embodiments of the present invention is shown in FIG. 2 as including a user interface devices 220 connected to serial interface 211. These user interface devices may include various player input devices such as mechanical buttons shown on button panel 106 in FIG. 1, and/or levers, and other devices. It will be appreciated that the interface between CPU 205 and other player input devices such as player card readers, voucher readers or printers, and other devices may be in the form or serial communications. Thus user serial interface 211 may be used for those additional devices as well, or the gaming machine may include one or more additional serial interface controllers. However, the interface between peripheral devices in the gaming machine, such as player input devices, is not limited to any particular type or standard for purposes of the present invention.

Reel Assembly 213 is shown in the diagrammatic representation of FIG. 2 to illustrate that a gaming machine which may be used for various embodiments of the invention may include mechanical reels. For example, a set of mechanical reels may replace the primary display device 104, or at least part of that display device. Alternatively, mechanical reels may be included in the gaming machine behind a light-transmissive video display panel. Although the invention is not limited to any particular mechanical reel arrangement or control system, mechanical reels may be controlled conveniently through serial communications which provide instructions for a respective stepper motor for each reel. Thus some embodiments of the present invention which employ mechanical reels may use a serial interface device such as serial interface controller 211 to control communications with the reel assembly, and may not include a dedicated interface as indicated by FIG. 2. Details of a mechanical reel arrangement are not shown in the present figures so as to avoid obscuring the present invention in unnecessary detail.

Referring now to FIG. 3, a networked gaming system 300 associated with one or more gaming facilities may include one or more networked gaming machines 100 (“electronic gaming machines” or “EGM's”) connected in the network by suitable network cable or wirelessly. Networked gaming machines 100 (Egm 1-Egm 4) and one or more overhead displays 413 may be operatively connected so that the overhead display or displays may mirror or replay the content of one or more displays of gaming machines 100. For example, the primary display content for a given gaming machine 100 may be stored by a display controller or game processor 205 of the given gaming machine and transmitted through network controller 210 to a controller associated with the overhead display(s) 313. In the event gaming machines 100 have cameras installed, the respective players' video images may be displayed on overhead display 313 along with the content of the player's gaming machine display.

The example gaming network 300 shown in FIG. 3 includes a host server 301 and floor server 302, which together may function as an intermediary between floor devices such as gaming machines 100 and back office devices such as the various servers described below. Game server 303 may provide server-based games and/or game services to network connected gaming devices such as gaming machines 100. Central determinant server 305 may be included in the network to identify or select lottery, bingo, or other centrally determined game outcomes and provide the information to networked gaming machines 100 providing lottery and bingo-based wagering games to players.

Progressive server 307 may accumulate progressive awards by receiving defined amounts, such as a percentage of the wagers from eligible gaming devices or by receiving funding from marketing or casino funds. Progressive server 307 may also provide progressive awards to winning gaming devices in response to a progressive event. Such a progressive event may comprise, for example, a progressive jackpot game outcome or other triggering event such as a random or pseudo-random win determination at a networked gaming device or server. Accounting server 311 may receive gaming data from each of the networked gaming devices, perform audit functions, and provide data for analysis programs. Player account server 309 may maintain player account records, and store persistent player data such as accumulated player points and/or player preferences (for example, game personalizing selections or options).

Example gaming network 300 also includes a gaming website 321 which may be hosted through web server 320 and may be accessible by players via the Internet. One or more games may be displayed as described herein and played by a player through a personal computer 323 or handheld wireless device 325 (for example, a Blackberry® cell phone, Apple® iPhone®, personal digital assistant (PDA), iPad®, etc.). To enter website 321, a player may log in with a user name that may, for example, be associated with the player's account information stored on player account server 409. Once logged onto website 321 the player may play various games on the website. Also website 321 may allow the player to make various personalizing selections and save the information so it is available for use during the player's a next gaming session at a casino establishment having the gaming machines 100.

It will be appreciated that gaming network 300 illustrated in FIG. 3 is provided merely as an example of a gaming network in which games featuring enhancement symbols according to embodiments of the present invention may be implemented, and is not intended to be limiting in any way. The invention is not limited to use in games offered through a gaming network (via the gaming website 321, or via gaming machines such as gaming machines 100, or otherwise). For example, games including enhancement symbols according to the present invention may be offered through a stand-alone gaming machine having a configuration similar to gaming machine 100 or having any other gaming machine configuration. Also, where games including enhancement symbols as described particularly below in connection with FIGS. 4-7 are offered through gaming machines included in a gaming network, the network need not have the configuration shown for purposes of example in FIG. 3. In particular, servers shown separately in the example of FIG. 3 may be combined in a single physical processing device, or the processing duties of the various illustrated servers may be split into additional physical devices.

FIG. 4 illustrates a process employing enhancement symbols according to an example embodiment of the present invention. The figure shows a single game play cycle representing an enhancement symbol process applied to a single play of a game. It will be appreciated that this single cycle will typically be repeated numerous times for a given gaming session at a gaming machine. In the following description of the process shown in FIG. 4, the complete process will first be described generally, and then the different constituent steps will be described in more detail along with certain variations associated with the individual steps.

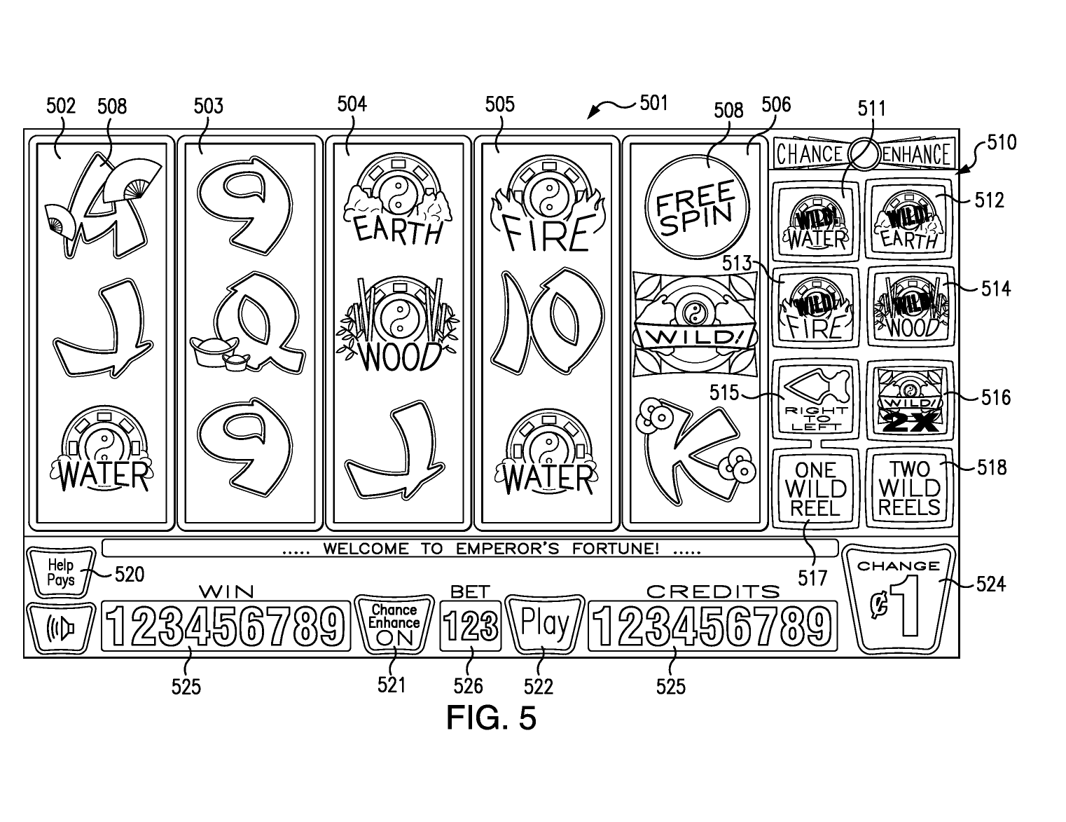

As shown in FIG. 4 the illustrated example method includes displaying enhancement symbols at a gaming machine as shown at process block 401. The method also includes receiving a wager and player input to initiate the play of a game offered through the gaming machine as shown at process block 402. As shown at process block 403, the method further includes generating an outcome for the play of the game which was initiated a process block 402, and displaying the outcome. The outcome may be displayed in the form of a graphical representation of the outcome, examples of which will be described further below in connection with FIGS. 5-7. The method shown in FIG. 4 also includes selecting at least one of the previously displayed enhancement symbols. This step is shown at process block 404. With the enhancement symbols selected, the method further includes applying a payout modification correlated to the selected enhancement symbol as shown at process block 405. This payout modification is applied to the payout that is correlated to the outcome displayed according to process block 403. The example method for the given game play then concludes with awarding the modified payout value for the play of the game as shown at process block 406.

Embodiments according to the present invention may employ numerous different techniques to display the enhancement symbols as indicated at process block 401. In forms of the invention implemented through a gaming machine having a video display, the enhancement symbols may be displayed through the video display device. Alternatively to a video display, embodiments of the invention may display enhancement symbols as static symbols that have been silkscreened or otherwise formed on a transparent material such as glass. In these static enhancement symbol display embodiments, the symbols may be highlighted using various back lighting or front lighting techniques or other lighting techniques, or combinations of these techniques, to accentuate the symbols and to indicate the selection of a given enhancement symbol according to process block 404 as described further below. Also, the invention is not limited to any particular location for displaying the enhancement symbols at the gaming machine. Some implementations of the invention display the enhancement symbols in an enhancement symbol area adjacent to an outcome display area which displays the graphic representation of the outcome for the given play of the game. This adjacent area may be to the left or right side of the outcome display area, or may be above or below the outcome display area. Some embodiments of the invention may position the enhancement symbols along more than one side of the outcome display area or along the entire perimeter of the outcome display area. In some embodiments, the enhancement symbols are displayed continuously at the gaming machine. In other embodiments, the enhancement symbols may not be displayed continuously but may be displayed from the time the player initiates the play of the game to the time the one or more enhancement symbols are selected in the process.

The present invention is not limited to displaying the enhancement symbols on the same display device used to display the game play outcome. For example, the outcome for a given game play may be displayed on a primary display device such as primary display device 104 shown in FIG. 1, while the enhancement symbols may be displayed on a different display device, such as display device 107, or 108, or 109 shown in FIG. 1, or using combinations of these display devices. That is, some of the enhancement symbols may be displayed on one display device and other enhancement symbols may be displayed on one or more other display devices in a given embodiment of the present invention.

The present invention also encompasses substantially any process by which a wager may be received and an input may be received to initiate a play of the game as shown at process block 402. In a typical wagering game arrangement, the player will insert cash into the gaming machine or insert a voucher or some other device at the gaming machine to make game play credits available at the machine. Once cash or credits are available for the play of a game offered at the gaming machine, the player may use gaming machine controls such as control buttons 110 shown in FIG. 1, or touch screen-implemented virtual buttons, to make a wager for the play of the game. Once the wager is placed and perhaps other options are selected, such as the number of activated paylines in a reel-type game for example, the player may activate a suitable control at the gaming machine (such as pressing a play button or pulling a play handle) to make an input which is received at the gaming machine to initiate a play of the game.

The invention also encompasses substantially any manner in which an outcome may be generated for the given play of the game as indicated at process block 403, and any arrangement or manner in which the outcome may be displayed to the player. In some implementations, the gaming machine itself includes processing capabilities for generating a random or pseudo-random outcome for a given play of the game and then selecting and appropriate graphic display to display that outcome. In other embodiments, the gaming machine or a system controlling the gaming machine may produce an outcome by stopping spinning reels at random locations such that the symbols shown by the stopped reels indicate an outcome for the game play. In yet other implementations, game play outcomes may be generated by a remote processing device or server which supplies outcomes for a number of different gaming machines. For example, any one of a number of gaming machines may generate a signal representing a request for an outcome for a given game play and a remote server may operate a random number generator or other process to provide a random or pseudo-random outcome for the requesting gaming machine. As another example, in bingo gaming systems a central bingo game controller may match drawn bingo numbers to bingo cards to generate bingo game outcomes which may then be communicated to gaming machines in the bingo gaming system. As yet another example, a central processing device may store a lottery pool or implement a lottery drawing process to provide game play outcomes to a number of different gaming machines. In these central result generation cases, either the central result generating element or the gaming machines themselves map the given outcome to a graphic representation of the outcome which is then displayed according to process block 403.

A graphic representation of an outcome may be displayed through symbols on one or more spinnable reels as in a mechanical or video slot machine. Alternatively, one or more spinnable mechanical or video-generated symbol-bearing wheels may be used to provide a graphic representation of the outcome. The manner in which a bingo card matches a ball draw in a bingo game may also provide a graphic representation of an outcome within the scope of the present invention, as may the manner in which selected lottery symbols match a lottery draw. A video-generated lottery scratch-off ticket or a video representation of a playing card game such as a poker game may also provide a graphic representation of a game outcome to which enhancement symbols may be applied according to the present invention. A mechanical or video-generated roulette wheel, physical or video-generated dice, or competitions such as a horse race, or any other graphic artifice, or combinations of any of these, may be used to provide a graphic representation of a game outcome within the scope of the present invention.

Regardless of the technique used to provide the outcome for the play of a game to which enhancement symbols are applied, and regardless of the graphic used to display the outcome, a given outcome of the game will be associated with an award level in a paytable, and this award level will be correlated to a payout value. Typically, a given game will provide multiple winning award levels. Of course, some game play outcomes will correspond to a loss which does not provide any pay or any benefit to the player for that given play. These outcomes may be thought of as also corresponding to an award level, but the defined payout for the award level is zero. For a reel-type game, such as the example game which will be described below in connection with FIG. 5, each winning award level corresponds to some combination of reel symbols which are displayed on the reels for a given play. The winning combination of symbols may be defined along a payline, defined as a scatter combination not associated with a payline, or in any other fashion. A losing play in a reel-type game is one in which the reel-symbols do not match any of defined winning combinations. In a playing card game such as a poker game, the paytable may be defined in terms of a hierarchy of poker hands, while in competition-type games the paytable may be defined in terms of the finishing position of one or more participants. It will be appreciated that the present application of enhancement symbols is not limited to any particular paytable arrangement.

Processes within the scope of the present invention also encompass any process or arrangement by which an enhancement symbol may be selected as shown at process block 404 in FIG. 4. In some embodiments, each enhancement symbol selected for a given play is selected randomly or pseudo-randomly by a suitable processing device. Such a random selection processing device may be included at the gaming machine or may be located remotely from the gaming machine. In other embodiments, the selection of an enhancement symbol may be dictated by an overall result which is generated for a given game play. For example, a given game play may cause a processing device to generate an overall result, and a processing device at the gaming machine or elsewhere may choose a combination of outcome displayed as shown at process block 403 in FIG. 4, and enhancement symbol selected as shown at process block 404, to produce that result. This process of generating an overall result for a given play and then using that overall result to choose an outcome to be displayed as at process block 403 and to also select an enhancement symbol as at block 404 may be particularly desirable in implementations where the underlying results are determined from a lottery game or a bingo game for example. Further, in some implementations of the invention, the player may participate in selecting an enhancement symbol. In these implementations, the enhancement symbols may be masked in some fashion for purposes of player selection and then all or some of the enhancement symbols may be displayed after the player makes their selection.

Regardless of the manner in which the enhancement symbol or symbols are selected, one or more embodiments of the invention include providing a visual indication that a given enhancement symbol has been selected for given play. This visual indication may be by highlighting the displayed enhancement symbol in a particular color or in brighter light, or may be by muting the display of non-selected enhancement symbols. The position of the selected enhancement symbol or symbols may or may not change as part of the visual indication of selection. For example, the selection of a given enhancement symbol shown on a video display device may cause the video display device to show the selected enhancement symbol to enlarge and/or move to another area of the video display device and this change in the video display may represent at least part of the visual indication that the enhancement symbol has been selected.

The application of the payout modification at process block 405 in FIG. 4 may be performed by a processing device at the gaming machine or remotely from the gaming machine in a gaming system in which the gaming machine is included. The manner in which the payout modification is applied will depend upon the nature of the modification. For example, the given enhancement symbol may be correlated to a multiplier. In this case, applying the payout modification includes applying the multiplier to the outcome generated and displayed according to process block 403. In other cases the payout modification correlated to a selected enhancement symbol may turn one or more symbols in the game wild. In this case applying the payout modification includes evaluating the symbols on the outcome display taking into account the additional wild symbols dictated by the selected enhancement symbol. Where the payout modification correlated to a selected enhancement symbol changes the manner in which symbols are evaluated, such as for example evaluating pay lines in a reel-type game from right-to-left in lieu of or in addition to left-to-right, applying the payout modification includes evaluating the displayed outcome using the additional or alternative evaluation rule.

It will be appreciated that if the outcome displayed as shown at process block 403 is not a winning outcome, the selected enhancement may not apply to produce an overall winning result for the play of the game. For example, where the displayed outcome is a non-winning symbol combination in a reel-type game or a non-winning hand in a poker game and where the selected enhancement symbol correlates to a payout modification comprising a multiplier, the multiplier will not apply to convert the non-winning outcome to a winning outcome. However, if the selected enhancement symbol correlates to a payout modification comprising a wild symbol or a rule by which an outcome is evaluated for example, the application of the payout modification may turn a non-winning outcome displayed according to process block 403 to a winning outcome. For example, an enhancement symbol correlating to a payout modification comprising an additional wild symbol may convert a non-winning symbol combination in a reel-type game to a winning combination once the indicated wild symbol is taken into consideration.

The payout modification indicated at process block 405 in FIG. 4 may or may not be accompanied by a modification in the way that the outcome for the game play is displayed. For example, where the selected enhancement symbol correlates to a multiplier, the outcome displayed according to process block 403 may not be modified visually as part of applying the payout modification. However, where the enhancement symbol correlates to a symbol to be considered wild for the given game play, the outcome display may actually change to show the given symbol appearing as a symbol which is considered wild for the game according to the paytable for the game. Various visual effects may be applied in this latter case. For example, where a video display device shows the outcome for the play of the game, the symbol defined as wild according to the payout modification correlated to the selected enhancement symbol may alternate between the symbol shown according to process block 403 and the wild symbol for the game as part of applying the payout modification at process block 405.

Once the modified payout value has been determined for the play of the game, the gaming system awards the modified payout value for that game play. This award of the modified payout value may be performed in any awarding arrangement employed by the given gaming system through which the invention is implemented. The award of the modified payout value will typically be shown on one or more display devices or meters at the gaming machine. It will be appreciated that the award may actually be made at or through an accounting server located remotely from the gaming machine, and maintaining a credit account for the gaming session in which the given game play is included.

It should be noted that the order of the process steps shown in FIG. 4 is shown just for purposes of example and is not intended to be limiting. For example, implementations of the invention may select an enhancement symbol and display the selected enhancement symbol prior to generating and displaying an outcome for the given play. The various process steps shown in FIG. 4 may be applied in any suitable order.

Furthermore, it is possible to implement the present play enhancement invention without including all of the process steps shown in FIG. 4. For example, plays in which one or more enhancement symbols may be applied may be free plays and thus not require a wager input by the player. As another example, a given play may be automated in some fashion so as not to require a player input to initiate the game play. This may be the case for a respin in a reel-type game for example.

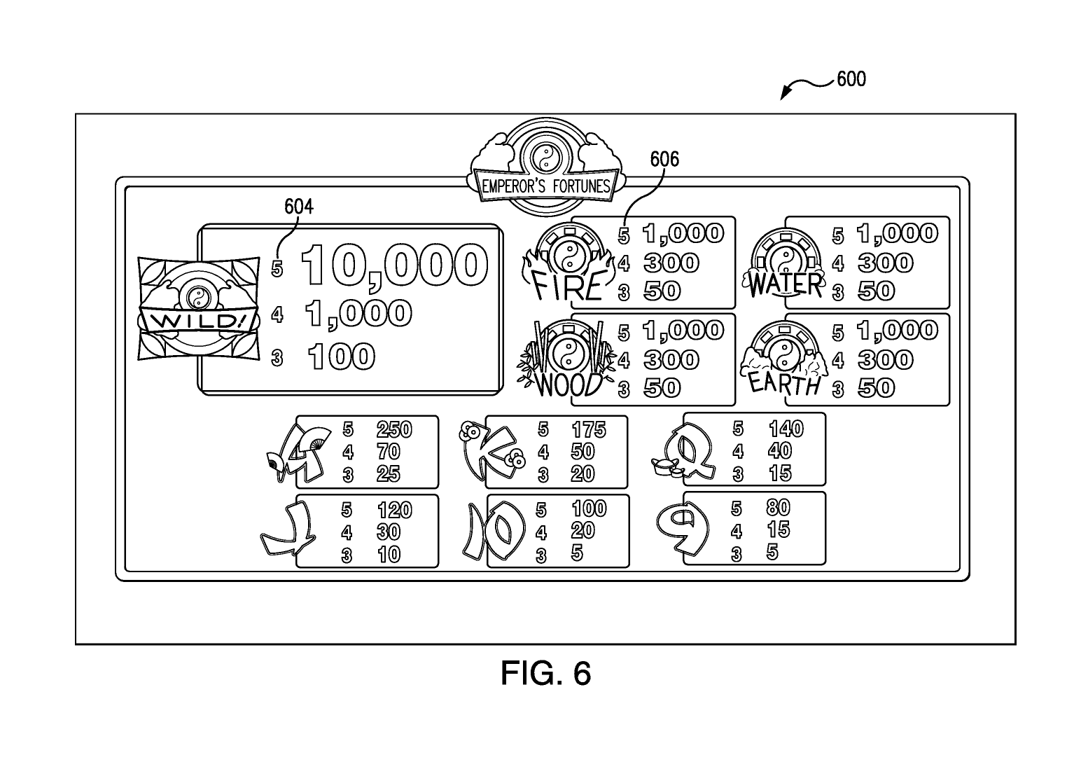

FIG. 5 shows an example of a reel-type game employing enhancement symbols according to an embodiment of the present invention. This sort of game may be displayed at a primary video display device such as display device 104 shown in the example gaming machine of FIG. 1. The graphic presentation for the game includes an outcome display area 501 which includes a series of video-generated reels 502, 503, 504, 505, and 506. Each of the reels in this particular example has three symbol locations for displaying various symbols 508. This arrangement of five reels, each displaying three vertically arranged symbol locations, produces a five-by-three array of symbols 508 through which array may be defined various paylines or other symbol arrangements which each correlate to an award in a paytable associated with the reel-type game. FIG. 6 shows an example paytable 600 which may be used with the game shown in FIG. 5. In this particular example, paytable 600 includes 19 winning award levels, each winning award level correlating to one or more symbol arrangements along a payline (or a scatter symbol arrangement) with a payout value. For example, payline symbol arrangement 604, defined as five aligned wild symbols, is correlated to a payout value of 10,000 (which may be expressed in credits or some denomination of currency), while payline symbol arrangement 606, five “Fire” symbols aligned along a payline, is correlated to a payout value of 1000. Any arrangement of symbols other than those shown correlated to a winning award level is correlated to a non-paying or losing award level.

Referring again to FIG. 5, the example reel-type game shows an array of enhancement symbols displayed in an enhancement symbol region 510 to the right of outcome display area 501. In this particular example, the enhancement symbols include eight different symbols 511-518. Each of the enhancement symbols 511, 512, 513, and 514 correlate to a payout modification which turns a certain symbol wild when the enhancement symbol is selected for the given play. When enhancement symbol 515 is selected for a given play, it provides a payout modification by causing pays to be determined from right-to-left in addition to left-to-right. Enhancement symbol 516, when selected for a given play, dictates that a wild symbol also becomes a multiplier for all payline wins. When selected for a given play, the final two enhancement symbols 517 and 518 provide a payout enhancement by dictating that one or two reels, respectively, become completely wild for the play (that is, each symbol 508 displayed in the stopped position of the reel is treated as a wild symbol or changes to become the predefined wild symbol). In an embodiment employing wild reel enhancement symbols such as symbols 517 and 518, the particular reel or reels to be treated as wild or converted to wild symbols may be randomly or pseudo-randomly selected. However, other embodiments may cause a predefined reel or reels to become wild, or may select the reel or reels to turn wild in any other suitable fashion. In one or more embodiments employing wild reel symbols such as symbols 517 and 518, or other reel-specific symbols, the player at the gaming machine may be allowed select the reels to which the effect will be applied. For example, the enhancement symbol may be selected and the player may select the reel or reels to which the payout modification effect is applied prior to the time that the reels stop spinning to show an outcome for a given play.

The example reel-type game display shown in FIG. 5 also includes a number of player controls such as virtual buttons 520, 521, 522, and 524, credit meters or displays 525, and a current bet display 526. Control button 521 may be used to activate the enhancement symbol feature according to one or more embodiments of the present invention. In particular, a player may be required to activate the enhancement symbol feature for a given play by pressing control button 521 or operating some alternative control device. Such an activation may make a side bet for the given play beyond any bet in the reel-type game to activate a given payline or other game feature. When activated, the virtual control button 521 may be illuminated or highlighted in some other fashion to indicate that the enhancement symbol feature is activated. Alternatively, control button 521 may be activated by default at the gaming machine and the player may be required to deactivate the enhancement symbol feature if that is desired. In still other embodiments, the player may not be given any option to activate or deactivate an enhancement symbol effect according to the present invention.

The example process shown in FIG. 4 may now be described in connection with the example reel-type game shown in FIG. 5. As shown in FIG. 5, the example game displays the enhancement symbols 511-518 in enhancement symbol display area 510. This display of enhancement symbols corresponds to the step shown at process block 401 in FIG. 4. The gaming machine through which the reel-type game is implemented then receives a wager and player input to initiate a game play according to the step shown at process block 402 in FIG. 4. In the example game graphic shown in FIG. 5, the bet may be entered through controls not shown in the figure, perhaps changing the denomination for the bet through denomination button 524, and the input to initiate the game play may be made by pressing virtual play button 522. An outcome for the play of the game is generated according to process block 403 in FIG. 4 by any of the processes described above in connection with that process block, and then the gaming machine implementing the reel-type game causes the virtual (that is, video-generated) reels 502-506 to spin and ultimately stop showing a symbol array such as the array of symbols 508 shown in FIG. 5. Once one of the enhancement symbols 511-518 in the example game shown in FIG. 5 is selected according to the step shown at process block 404 in FIG. 4, the selected payout modification correlated to that selected symbol may be applied to the displayed outcome according to the step shown at process block 405 in FIG. 4. For example, assume that the symbols displayed across the payline defined by the middle row of symbols show all Jack symbols (that is, “J” symbols), except for the middle row symbol in on the last reel 506, which shows the standard wild symbol. Assume also that the selected enhancement symbol comprises symbol 516, the wild multiplier enhancement symbol. In this case, the standard paytable for the game shows a payout of 120 credits for the five aligned Jack symbols (4 Jack symbols plus the wild symbol). However, applying the payout modification correlated to symbol 516 causes the paytable payout to be doubled to a modified payout value of 240 credits. This modified payout value is then awarded to the player in accordance with the step at process block 406 in FIG. 4.

FIG. 6 provides another example of a game applying enhancement symbols according to an embodiment of the present invention. In this example, the game is a poker game which may be displayed on a video display device such as display device 104 shown in FIG. 1. The poker game uses five playing card representations Card 1 through Card 5 displayed in an outcome display area 702. Six enhancement symbols ES_1 through ES_6 are displayed in enhancement symbol display area 704. Various touch screen-implemented player controls are included in player control area 705, and windows showing total credits, credits for the previous win, and credits for the current bet may be included in display area 706.

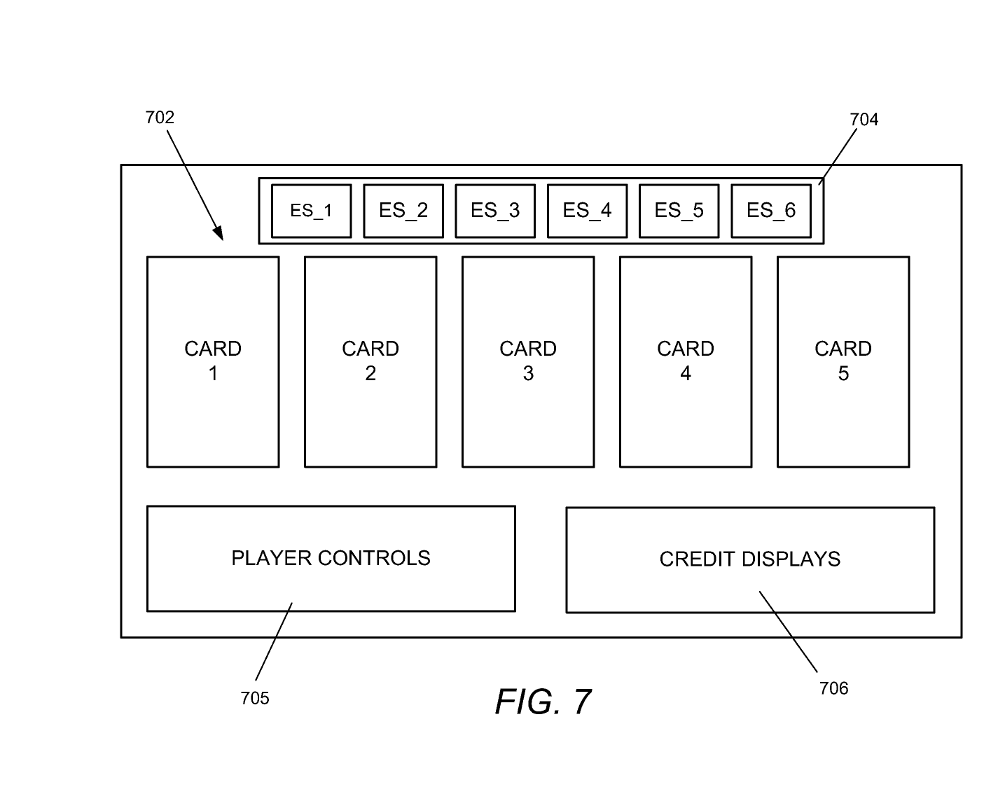

The method illustrated in FIG. 4 applies to the playing card game shown in FIG. 7 similarly to the previously described, example reel-type game. In the player card game shown in FIG. 7, enhancement symbols ES_1 through ES_6 are displayed according to the step shown at process block 401 in FIG. 4. The gaming machine implementing the poker game receives a player input to initiate a play in the game through player controls in player control area 605. This receipt of the game initiating input corresponds to the process step shown at block 402 in FIG. 4. An outcome for the play and a graphic representation for the outcome is displayed in the form of the playing cards Card 1 through Card 5, in accordance with the process step shown at process block 403 in FIG. 4. One or more of the enhancement symbols ES_1 through ES_6 are selected in accordance with block 404 in FIG. 4, and the payout modification associated with the selected enhancement symbol or symbols are applied in accordance with the step shown at process block 405 in FIG. 4. This payout modification modifies the payout that would be awarded for the resulting card hand according to the paytable for the card game (which may be a paytable based on poker hand hierarchy in this case). Ultimately the modified payout value is awarded for the play of the game in accordance with the process step shown at process block 406 in FIG. 4.

Although the example reel-type game discussed in connection with FIGS. 5 and 6, and the poker game discussed in connection with FIG. 7 provide good examples of how enhancement symbols may be applied in embodiments of the present invention, it should be appreciated that the present invention is by no means limited to these types of games. Rather, the enhancement symbol feature disclosed herein is applicable to substantially any wagering game. Also, a wide variety of payout modifications may be correlated to enhancement symbols according to the present invention.

It should also be noted that although the example games shown in FIGS. 5-7 suggest a static number of enhancement symbols (eight in the case of FIG. 5 and six in the case of FIG. 7), the number of enhancement symbols need not be static from one play to another. In various embodiments of the present invention, the number of enhancement symbols and the correlated payout modifications may vary between plays in any suitable manner. For example, in some implementations the number of enhancement symbols, and the desirability of the payout modifications, may increase over the length of time that a player plays at a given gaming machine to encourage longer playing sessions. Also, some implementations may have a number of enhancement symbols that correspond to a bet level for a given play. For example, a higher number of enhancement symbols may be available for a higher bet level.

It is also possible within the scope of the present invention that the enhancement symbols are not applied to every play at the gaming machine. Some implementations may require a side bet or certain minimum bet level to activate the enhancement symbol feature, or may activate the enhancement symbol feature on randomly designated plays of a given gaming machine, or to plays initiated after some minimum number of plays for a given gaming session at a gaming machine.

As used in the foregoing description and the following claims, the terms “comprising,” “including,” “carrying,” “having,” “containing,” “involving,” and the like are to be understood to be open-ended, that is, to mean including but not limited to. Any use of ordinal terms such as “first,” “second,” “third,” etc., in the claims to modify a claim element does not by itself connote any priority, precedence, or order of one claim element over another, or the temporal order in which acts of a method are performed. Rather, unless specifically stated otherwise, such ordinal terms are used merely as labels to distinguish one claim element having a certain name from another element having a same name (but for use of the ordinal term).

The above-described example embodiments are intended to illustrate the principles of the invention, but not to limit the scope of the invention. Various other embodiments and modifications to these preferred embodiments may be made by those skilled in the art without departing from the scope of the present invention.

1. A method including:
displaying a number of enhancement symbols concurrently on a display device included at a gaming machine, each enhancement symbol being correlated to a payout modification;
receiving a wager at the gaming machine and initiating a play of a game available through the gaming machine, the game being associated with a paytable providing at least one award level which is correlated to a respective payout value;
generating an outcome for the play of the game and displaying a graphical representation of the outcome;
continuing to display the number of enhancement symbols between the time that the play of the game is initiated and the time that the graphical representation of the outcome is displayed;
randomly selecting one of the enhancement symbols, and visually indicating at the gaming machine that the selected enhancement symbol has been selected;
applying the payout modification correlated to the selected enhancement symbol to identify a modified payout value for the play of the game, the modified payout value being different from the payout value for the outcome that would be provided according to the paytable; and
awarding the modified payout value for the play of the game.

2. The method of claim 1 wherein the respective payout modification associated with at least one of the enhancement symbols increases the payout value for the outcome shown in the paytable.

3. The method of claim 1 wherein the respective payout modification associated with at least one of the enhancement symbols increases the number of winning outcomes over the number of winning outcomes shown in the paytable.

4. The method of claim 1 wherein the number of enhancement symbols are displayed in an array adjacent to a game outcome display location in which the graphic representation of the outcome is displayed.

5. The method of claim 1 wherein the graphic representation of the outcome is displayed through an array of reel symbols on a number of mechanical or video-generated reels.

6. The method of claim 5 wherein one of the enhancement symbols comprises a wild reel enhancement symbol, and when the wild reel enhancement symbols is the selected enhancement symbol, further including randomly selecting one of the mechanical or video-generated reels and displaying each of the reel symbols shown on that reel as a wild symbol defined in the paytable as representing any one of two or more symbols in a set of reel symbols for the game.

7. The method of claim 6 further including displaying a predetermined symbol on the randomly selected reel in addition to the wild symbol.

8. The method of claim 5 wherein the outcome of the play awards a number of free plays of the game, and further including:
generating a respective outcome in the game for each respective free play; and
applying the payout modification correlated to the selected enhancement symbol to one or more of the free play outcomes.

9. The method of claim 1 wherein the graphic representation of the outcome is displayed through an array of video-generated playing card representations.

10. A gaming system including:
at least one display device;
a player input system;
at least one processor; and
at least one memory device storing instructions executable by the at least one processor to:
cause the at least one display device to concurrently display a number of enhancement symbols, each enhancement symbol being correlated to a payout modification;
generate an outcome for the play of a game in response to a wager entered through the player input system, the game being associated with a paytable providing at least one award level which is correlated to a respective payout value;
cause the at least one display device to display a graphical representation of the outcome and continue to display the number of enhancement symbols between the time that the wager is entered and the time that the graphical representation of the outcome is displayed;
randomly select one of the enhancement symbols;
cause the at least one display device to visually indicate that the selected enhancement symbol has been selected;
apply the payout modification correlated to the selected enhancement symbol to identify a modified payout value for the play of the game, the modified payout value being different from the payout value for the outcome that would be provided according to the paytable; and award the modified payout value for the play of the game.

11. The gaming system of claim 10 wherein the respective payout modification associated with at least one of the enhancement symbols increases the payout value for the outcome shown in the paytable.

12. The gaming system of claim 10 wherein the respective payout modification associated with at least one of the enhancement symbols increases the number of winning outcomes over the number of winning outcomes shown in the paytable.

13. The gaming system of claim 10 wherein the at least one display device displays the number of enhancement symbols in an array adjacent to a game outcome display location in which the graphic representation of the outcome is displayed.

14. The gaming system of claim 10 wherein the at least one display device displays the graphic representation of the outcome through an array of reel symbols on a number of mechanical or video-generated reels.

15. The gaming system of claim 14 wherein one of the enhancement symbols comprises a wild reel enhancement symbol, and when the wild reel enhancement symbols is the selected enhancement symbol, the at least one processor randomly selects one of the mechanical or video-generated reels and causes the at least one display device to display each of the reel symbols shown on that reel as a wild symbol defined in the paytable as representing any one of two or more symbols in a set of reel symbols for the game.

16. The gaming system of claim 15 wherein the at least one processing device also causes the at least one display device to display a predetermined symbol on the randomly selected reel in addition to the wild symbol.

17. The gaming system of claim 14 wherein the outcome of the play awards a number of free plays of the game, and wherein the at least one processor also:
generates a respective outcome in the game for each respective free play; and
applies the payout modification correlated to the selected enhancement symbol to one or more of the free play outcomes.

18. The gaming system of claim 10 wherein the at least one display device displays the graphic representation of the outcome through an array of video-generated playing card representations.

19. A program product stored on one or more computer readable non-transitory data storage devices, the program product including:
player input program code executable by at least one processor to receive a wager at a gaming machine and initiating a play of a game available through a gaming machine in response to a player input at the gaming machine, the game being associated with a paytable providing at least one award level which is correlated to a respective payout value;
game program code executable by the at least one processor to generate an outcome for the play of the game
display program code executable by the at least one processor to cause at least one display device to display a graphical representation of the outcome and to display a number of enhancement symbols between the time that the play of the game is initiated and the time that the graphical representation of the outcome is displayed, the number of enhancement symbols being concurrently displayed by the at least one display device and each enhancement symbol being correlated to a payout modification;
play enhancement program code executable by the at least one processor to (i) randomly select one of the enhancement symbols, and visually indicating at the gaming machine that the selected enhancement symbol has been selected, and (ii) apply the payout modification correlated to the selected enhancement symbol to identify a modified payout value for the play of the game, the modified payout value being different from the payout value for the outcome shown by the paytable; and
payout program code executable by the at least one processor to award the modified payout value for the play of the game.

20. The program product of claim 19 wherein the outcome of the play awards a number of free plays of the game, and wherein:
the game program code is also executable by the one or more processors to generate a respective outcome in the game for each respective free play; and
the play enhancement program code applies the payout modification correlated to the selected enhancement symbol to one or more of the free play outcomes.
